(19) United States
(12) Patent Application Publication
(10) Pub. No.: US 2022/0120905 A1
(43) Pub. Date: Apr. 21, 2022

(54) Speed Determination Using Light Detection and Ranging (LIDAR) Device

(71) Applicant: Waymo LLC, Mountain View, CA (US)

(72) Inventor: Luke Wachter, San Francisco, CA (US)

(21) Appl. No.: 17/482,725

(22) Filed: Sep. 23, 2021

Related U.S. Application Data
(60) Provisional application No. 63/092,056, filed on Oct. 15, 2020.

(51) Int. Cl. G01S 17/58; G01S 7/48; G01S 7/484; G01S 7/486

(52) U.S. Cl. CPC G01S 17/58; G01S 7/486; G01S 7/484; G01S 7/4808

(57) ABSTRACT

A light detection and ranging (LIDAR) device includes a first light emitter, a second light emitter, a first light detector, and a second light detector, wherein the first light emitter is configured to emit light pulses in a first direction and the second light emitter is configured to emit light pulses in a second direction. During a scan of the LIDAR device, the first direction intersects an object at a first time and the second direction intersects the object at a second time. A relative speed of the object can be determined based on a first range to the object when the first direction intersects the object and a second range to the object when the second direction intersects the object.

### CROSS-REFERENCE TO RELATED APPLICATIONS

This application claims priority to U.S. Provisional Patent Application No. 63/092,056, filed Oct. 15, 2020, which is incorporated herein by reference.

### BACKGROUND

Unless otherwise indicated herein, the materials described in this section are not prior art to the claims in this application and are not admitted to be prior art by inclusion in this section.

Autonomous vehicles use various computing systems to aid in the transport of passengers from one location to another. Some autonomous vehicles may require some initial input or continuous input from an operator, such as a pilot, driver, or passenger. Other systems, such as autopilot systems, may be used only when the system has been engaged, which permits the operator to switch from a manual mode (where the operator exercises a high degree of control over the movement of the vehicle) to an autonomous mode (where the vehicle essentially drives itself) to modes that lie somewhere in between.

Such vehicles are equipped with various types of sensors in order to detect the status of the vehicle as well as objects in the surroundings. For example, autonomous vehicles may include inertial sensors, lasers, sonar, radar, cameras, and other devices that scan and record data from the vehicle and its surroundings.

One such sensor is a light detection and ranging (LIDAR) device. A LIDAR device may be used to determine a range and direction to an object in its environment by emitting a light pulse in a particular direction toward the object and detecting a returning light pulse that corresponds to a portion of the emitted light pulse that is reflected by the object. The range may be calculated based on a time difference between when the light pulse is emitted and when the returning light pulse is detected.

A speed of the object (relative to the LIDAR device) may also be estimated based on the determined range to the object changing over time. The efficiency of this approach, however, depends on the frequency at which the LIDAR device emits light pulses in the object's direction. For example, a LIDAR device may rotate about an axis while emitting light pulses in order to scan the environment through a 360-degree azimuth. In that case, the relative speed of the object may be calculated by comparing the ranges to the object that are determined for successive rotations of the LIDAR device. This approach, however, results in a delay of a full rotation before getting an estimate of the object's speed. For a LIDAR device that rotates at 10 Hz, the delay associated with a full rotation is 0.1 seconds, which adds a significant amount of latency in estimating the relative speed of an object. At this level of latency, an object with a relative speed of 30 miles per hour will move 4.4 feet (relative to the LIDAR device) in the 0.1 seconds between measurements.

Thus, there is a need to provide more efficient approaches for using a LIDAR device to estimate the speed of an object.

### SUMMARY

In one aspect, a method is provided. A light detection and ranging (LIDAR) scans about an axis such that a first direction of the LIDAR device intersects an object at a first time and a second direction of the LIDAR device intersects the object at a second time. The first and second directions have different yaw angles in a reference plane perpendicular to the axis. The yaw angle difference could be, for example, less than 90 degrees, or less than 10 degrees. The LIDAR device includes a first light emitter, a second light emitter, a first light detector, and a second light detector. The first light emitter is configured to emit light pulses in the first direction, and the second light emitter is configured to emit light pulses in the second direction. The first light emitter emits a first emitted light pulse at a first emission time and the first light detector detects a first detected light pulse at a first detection time, in which the first detected light pulse corresponds to reflection of the first emitted light pulse by the object. The second light emitter emits a second emitted light pulse at a second emission time and the second light detector detects a second detected light pulse at a second detection time, in which the second detected light pulse corresponds to reflection of the second emitted light pulse by the object. A first range to the object is determined based on a difference between the first emission time and the first detection time. A second range to the object is determined based on a difference between the second emission time and the second detection time. A relative speed of the object is determined based on the first range, the second range, the first time, and the second time.

In another aspect, a system is provided. The system includes a light detection and ranging (LIDAR) device and a computing device coupled to the LIDAR device. The LIDAR device is configured to scan about an axis and includes a first light emitter, a second light emitter, a first light detector, and a second light detector. The first light emitter is configured to emit light pulses in a first direction. The second light emitter is configured to emit light pulses in a second direction. The first and second directions have different yaw angles in a reference plane perpendicular to the axis. The yaw angle difference could be, for example, less than 90 degrees, or less than 10 degrees. The computing device comprises a processor and data storage that stores instructions that are executable by the processor to perform operations. The operations include: (a) receiving, from the LIDAR device, data indicative of a first emitted light pulse emitted by the first light emitter at a first emission time and a first detected light pulse detected by the first light detector at a first detection time, in which the first detected light pulse corresponds to reflection of the first emitted light pulse by an object; (b) receiving, from the LIDAR device, data indicative of a second emitted light pulse emitted by the second light emitter at a second emission time and a second detected light pulse detected by the second light detector at a second detection time, in which the second detected light pulse corresponds to reflection of the second emitted light pulse by the object; (c) determining a first range to the object based on a difference between the first emission time and the first detection time; (d) determining a second range to the object base on a difference between the second emission time and the second detection time; and (e) determining a relative speed of the object based on the first range, the second range, a first time when the first direction intersects the object, and a second time when the second direction intersects the object.

In yet another aspect, a non-transitory computer readable medium is provided. The non-transitory computer readable medium stores instructions that are executable by one or more processors to perform operations, including: (a) receiving, from a LIDAR device, data indicative of a first emitted light pulse emitted by a first light emitter at a first emission time and a first detected light pulse detected by a first light detector at a first detection time, in which the first detected light pulse corresponds to reflection of the first emitted light pulse by an object and the first light emitter is configured to emit light pulses in a first direction; (b) receiving, from the LIDAR device, data indicative of a second emitted light pulse emitted by a second light emitter at a second emission time and a second detected light pulse detected by a second light detector at a second detection time, in which the second detected light pulse corresponds to reflection of the second emitted light pulse by the object and the second light emitter is configured to emit light pulses in a second direction, the first and second directions having different yaw angles (e.g., a yaw angle difference that is less than 90 degrees or less than 10 degrees); (c) determining a first range to the object based on a difference between the first emission time and the first detection time; (d) determining a second range to the object base on a difference between the second emission time and the second detection time; and (e) determining a relative speed of the object based on the first range, the second range, a first time when the first direction intersects the object, and a second time when the second direction intersects the object.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a diagram of a light detection and ranging (LIDAR) device that includes a first channel the emits light pulses in a first direction, a second channel that emits light pulses in a second direction, and a third channel that emits light pulses in a third direction, according to an example embodiment.

FIGS. 2A-2C are diagrams illustrating, from a top view, a scenario in which the LIDAR device of FIG. 1 interacts with an object while the LIDAR device scans, according to an example embodiment. FIG. 2A shows the LIDAR device at a first time (T1) when the first direction intersects the object. FIG. 2B shows the LIDAR device at a second time (T2) when the second direction intersects the object. FIG. 2C shows the LIDAR device at a third time (T3) when the third direction intersects the object.

FIG. 3 is a diagram that illustrates a range of yaw angles and a range of pitch angles for channels of a LIDAR device, according to an example embodiment.

FIG. 4 is a diagram illustrating, from a side view, the scenario shown in FIGS. 2A-2C, according to an example embodiment.

FIG. 5A illustrates a vehicle equipped with a sensor system, according to an example embodiment.

FIG. 5B illustrates a vehicle equipped with a sensor system, according to an example embodiment.

FIG. 5C illustrates a vehicle equipped with a sensor system, according to an example embodiment.

FIG. 5D illustrates a vehicle equipped with a sensor system, according to an example embodiment.

FIG. 5E illustrates a vehicle equipped with a sensor system, according to an example embodiment.

FIG. 6 is a simplified block diagram of a vehicle, according to example embodiments.

FIG. 7 is a flowchart of a method, according to example embodiments.

### DETAILED DESCRIPTION

Exemplary implementations are described herein. It should be understood that the word “exemplary” is used herein to mean “serving as an example, instance, or illustration.” Any implementation or feature described herein as “exemplary” or “illustrative” is not necessarily to be construed as preferred or advantageous over other implementations or features. In the figures, similar symbols typically identify similar components, unless context dictates otherwise. The example implementations described herein are not meant to be limiting. It will be readily understood that the aspects of the present disclosure, as generally described herein and illustrated in the figures, can be arranged, substituted, combined, separated, and designed in a wide variety of different configurations.

A light detection and ranging (LIDAR) device may be used to determine a distance or range to an object by emitting a light pulse from a light emitter and detecting, by a light detector, a returning light pulse that corresponds to a portion of the emitted light pulse that has been reflected by an object in the environment of the LIDAR device. The range, R, to the object can be calculated as follows:

R=(cΔt)/2 (1)

where Δt is the time difference between when the light pulse is emitted and when the returning light pulse is detected, and where c is the speed of light.

In example embodiments, the LIDAR device includes multiple channels, in which each channel includes or is otherwise associated with at least one light emitter paired with at least one light detector. For each given channel, the light detector is configured to detect returning light pulses that correspond to reflections of light pulses emitted by the light emitter of that given channel.

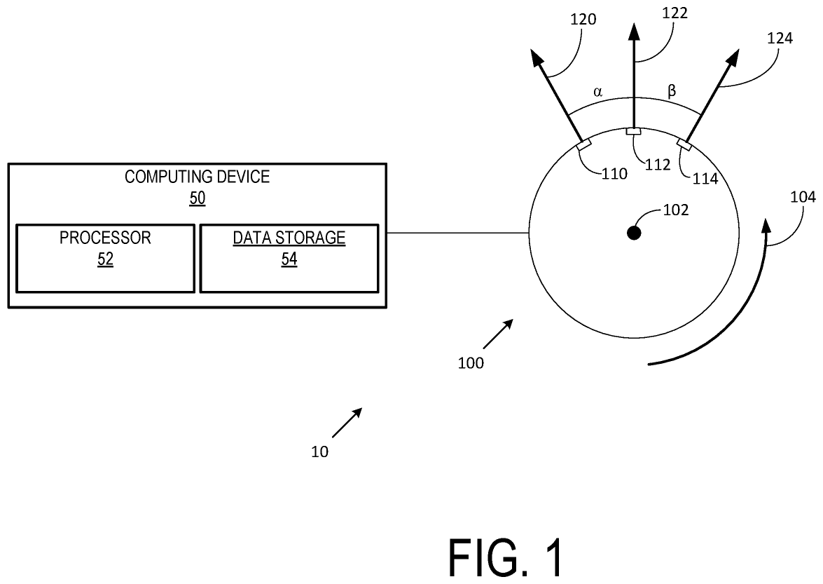

The different channels can be arranged to emit light in different directions. FIG. 1 illustrates an example of such an arrangement. In this example, a sensor system 10 includes a LIDAR device 100 operably coupled to a computing device 50. The LIDAR device 100 scans about an axis 102 in a direction indicated by arrow 104 and includes channels 110, 112, and 114. As shown, channel 110 is configured to emit light pulses in a first direction 120, channel 112 is configured to emit light pulses in a second direction 122, and channel 114 is configured to emit light pulses in a third direction 124. The different directions have different yaw angles, which may be defined as angles in a reference plane that is perpendicular to the axis 102. In the example illustrated in FIG. 1, the first direction 120 and second direction 122 have a yaw angle difference of a, and the second direction 122 and third direction 124 have a yaw angle difference of β. In example embodiments, α and β are each less than 90 degrees. In particular embodiments, α and β are each less than 10 degrees.

The different directions could also have different pitch angles, which may be defined as angles with respect to the reference plane. In example embodiments, the first direction 120, second direction 122, and third direction 124 could include positive pitch angles (e.g., upward directions) and/or negative pitch angles (e.g., downward directions), and may differ in pitch angle by less than 90 degrees (or less than 10 degrees). Although FIG. 1 shows LIDAR device 100 with three channels that emit light in three different directions, it is to be understood that a LIDAR device could include any number of channels that emit light in any number of directions. For example, a LIDAR device could include an array of channels that span a range of yaw directions and a range of pitch angles.

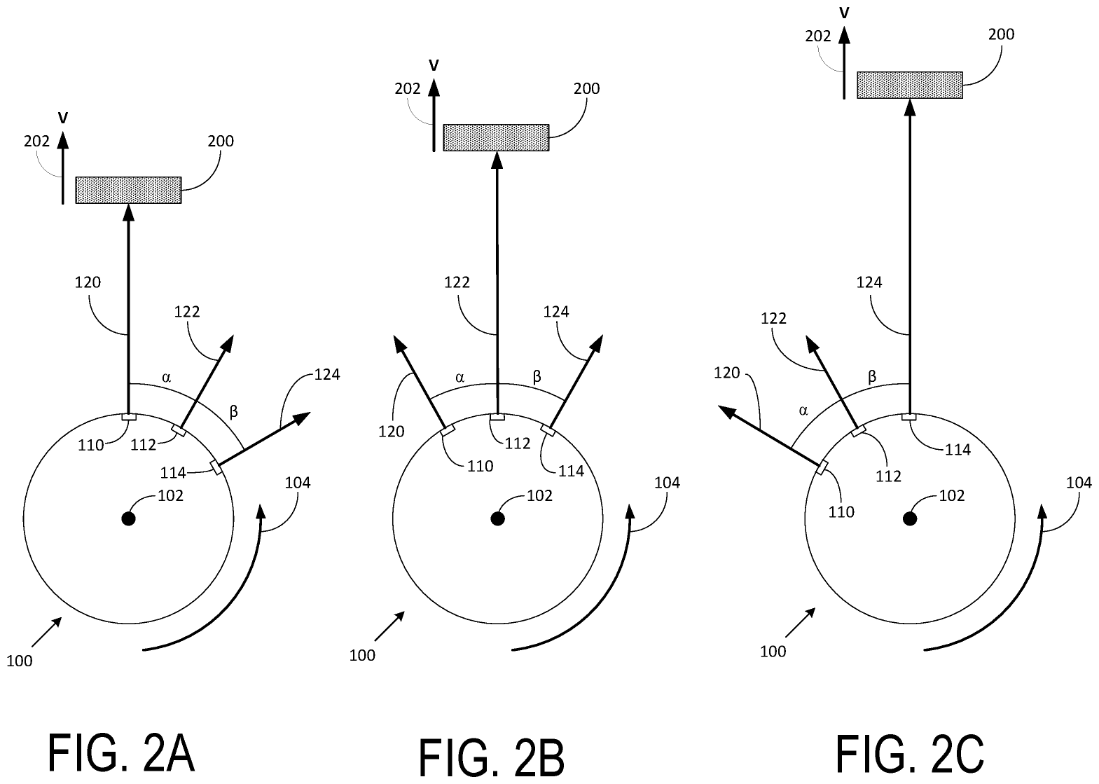

As the LIDAR device 100 shown in FIG. 1 scans about axis 102, the channels 110, 112, and 114 may emit light pulses at a pulse rate that is much higher than the LIDAR's scanning rate. For example, the LIDAR device 100 may scan (such as by rotating, beam steering, and/or other scanning mechanisms) at a rate between 3 Hz to 30 Hz, such as 10 Hz. Taking 10 Hz as an example, the channels 110, 112, and 114 may each emit light pulses at a pulse rate of 100 kHz. This much higher pulse rate enables the LIDAR device 100 to measure ranges to the same object in one 360-degree scan (herein referred to as a rotation) using each of channels 110, 112, and 114. Any difference in the ranges to the object measured using the channels can be used to determine a speed of the object relative to the LIDAR device 100. An example of this approach is illustrated in FIGS. 2A-2C.

The computing device 50 includes a processor 52 and data storage 54. The computing device 50 receives data from the LIDAR device 100. The processor 52 executes instructions stored on the data storage 54 in order to calculate the relative speed of an object based on the data from two or more channels as described herein. In some forms, the computing device 50 is further configured to transmit control signals to the LIDAR device 100 to control operation thereof.

Processor 52 may comprise one or more general-purpose processors and/or one or more special-purpose processors. To the extent that processor 52 includes more than one processor, such processors could work separately or in combination. Data storage 54 may comprise one or more volatile and/or one or more non-volatile storage components, such as optical, magnetic, and/or organic storage, and data storage 54 may be integrated in whole or in part with processor 52.

In FIGS. 2A-2C, LIDAR device 100 scans about axis 102 while channels 110, 112, and 114 emit light pulses, and the light pulses are used to measure a relative speed, V, of an object 200. In the example of FIGS. 2A-2C, the axis 102 is a vertical axis, and the object 200 is moving away from the LIDAR device 100 in a horizontal direction, as indicated by arrow 202. For example, the LIDAR device 100 could be coupled to a vehicle that is travelling on a road, and the object 200 could be another vehicle travelling on the road, either ahead of or behind the vehicle that has the LIDAR device 100. In general, object 200 could be any type of object that is either moving or stationary relative to the relative to the LIDAR device 100. For example, object 200 could be a vehicle, a pedestrian, a sign, a traffic cone, or some other type of object. Accordingly, object 200 could be moving or stationary relative to the vehicle on which the LIDAR device 100 may be coupled, depending on whether and how the vehicle is moving.

FIG. 2A shows the orientation of the LIDAR device 100 at a time T1, when the first direction 120 of first channel 110 intersects the object 200. Subsequently, as the LIDAR device 100 scans about axis 102, the second direction 122 of second channel 112 intersects the object 200 at a time T2 shown in FIG. 2B. Thereafter, as the LIDAR device 100 continues to scan about axis 102, the third direction 124 of third channel 114 intersects the object 200 at a time T3 shown in FIG. 2C.

In this example, the times T1, T2, and T3 occur during one complete rotation of the LIDAR device 100 about the axis 102. Taking the period of rotation as P, and α and β measured in degrees, the times T1, T2, and T3 may be selected so that the time differences are related to P, α, and β as follows (or as closely as possible given the pulse rate of the channels 110, 112, and 114):

T2−T1=P(α/360) (2)

T3−T2=P(β/360) (3)

For example, if the period of rotation is 0.1 seconds (i.e., the LIDAR device scans at 10 Hz), and α is 5 degrees, then T2−T1 is about 1.39 milliseconds.

In the orientation of LIDAR device 100 shown in FIG. 2A, with the first direction 120 intersecting the object 200, the first channel 110 emits a light pulse toward the object 200 and receives a returning light pulse from the object 200. The time difference between the time the light pulse is emitted and the time the returning light pulse is detected can be used to determine a first range R1 to the object 200 using equation (1). The first range R1 is associated with the time T1, which could be any time when the first direction 120 intersects the object 200 (e.g., the time T1 could be taken as the time when the light pulse is emitted, the time when the returning pulse is detected, or an average of these times).

Similarly, in the orientation of LIDAR device 100 shown in FIG. 2B, with the second direction 122 intersecting the object 200, the second channel 112 emits a light pulse toward the object 200 and receives a returning light pulse from the object 200. The time difference between the time the light pulse is emitted and the time the returning light pulse is detected can be used to determine a second range R2 to the object 200. The second range R2 is associated with the time T2, which could be any time when the second direction 122 intersects the object 200.

Likewise, in the orientation of LIDAR device 100 shown in FIG. 2C, with the third direction 124 intersecting the object 200, the third channel 114 emits a light pulse toward the object 200 and receives a returning light pulse from the object 200. The time difference between the time the light pulse is emitted and the time the returning light pulse is detected can be used to determine a third range R3 to the object 200. The third range R3 is associated with the time T3, which could be any time when the third direction 124 intersects the object 200.

In an illustrative example, the directions 120, 122, 124 all have a pitch angle of zero, such that they are all horizontal directions that are parallel to the direction of motion 202 of object 200. In that case, the relative speed, V, of the object 200 is simply the difference between any of the ranges R1, R2, R3 divided by the difference between the corresponding times T1, T2, T3. Thus, V could be calculated as (R2−R1)/(T2−T1), as (R3−R1)/(T3−T1), as (R3−R2)/(T3−T2), or as a best fit to the measured ranges and the corresponding times.

Thus, if V corresponds to typical driving speeds, and the yaw angle difference, a, between first direction 120 and second direction 122 is a few degrees, the resulting range difference between R1 and R2 or between R2 and R3 could be a few centimeters. For example, if LIDAR device 100 scans at 10 Hz (i.e., a period of rotation of 0.1 seconds) and a is 5 degrees, then a relative speed of 25 mph results in a range difference of about 1.55 cm and a relative speed of 50 mph results in a range difference of about 3.1 cm.

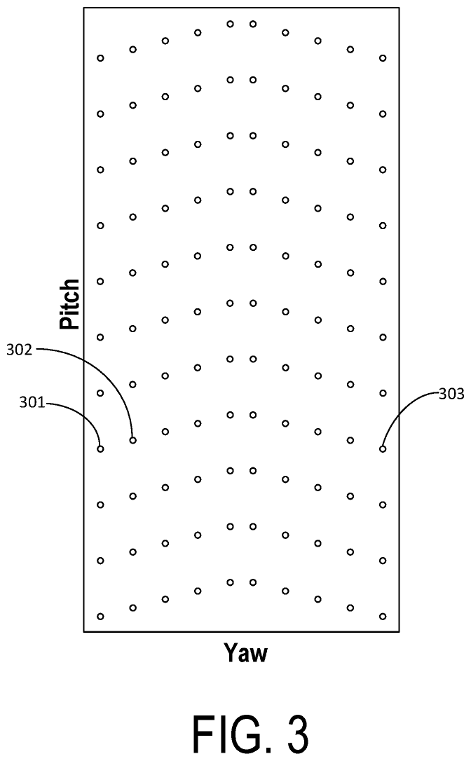

In some implementations, however, one or more of the directions 120, 122, 124 could have a non-zero pitch angle. For example, a LIDAR device may have channels with directions that span a range of yaw angles and a range of pitch angles, as illustrated in FIG. 3. In FIG. 3, the position of each circle represents a pitch angle and a yaw angle of a particular channel of an example LIDAR device. In principle, any of the channels could be used to determine the relative speed of an object. However, it can be beneficial to select a set of three or more channels that span a relatively small range of pitch angles in order to minimize the effect of the shape of the object and a relatively large range of yaw angles in order to detect a significant change in the measured ranges to the object. Based on these criteria, for example, channels 301, 302, and 303 shown in FIG. 3 could be used to measure the relative speed of an object.

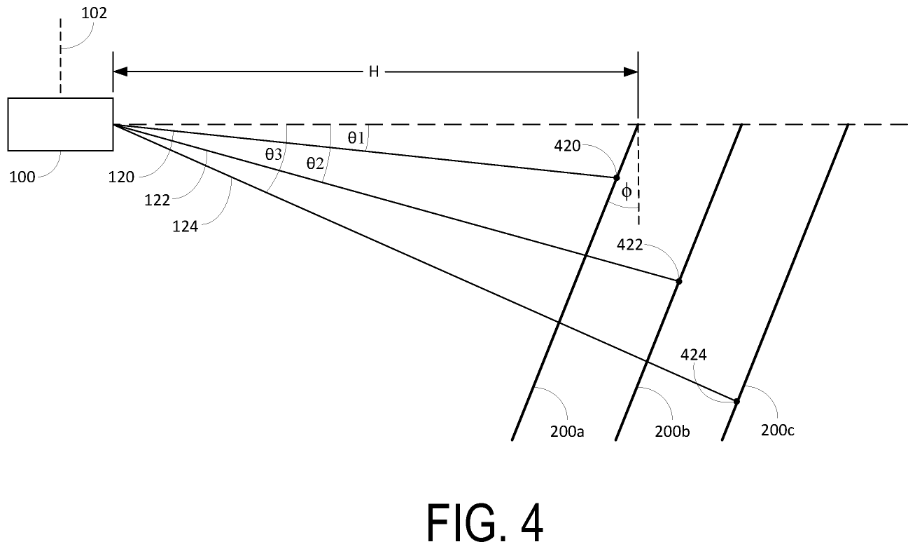

Thus, the directions 120, 122, 124 used to measure the relative speed of the object 200 in the scenario illustrated in FIGS. 2A-2C could each have a different, non-zero pitch angle. In that case, the directions 120, 122, 124 intersect the object 200 at different locations. The shape of the object 200 could therefore affect the ranges that are measured using different directions. This is illustrated in FIG. 4.

In FIG. 4, the directions 120, 122, and 124 have pitch angles θ1, θ2, and θ3, respectively. For purposes of illustration, θ3 is shown to be greater than θ2, and θ2 is shown to be greater than θ1. In general, however, the pitch angles corresponding to the directions 120, 122, and 124 could differ in other ways, or some of the pitch angles could be the same.

In the example shown in FIG. 4, object 200 is moving away from the LIDAR device 100 in a horizontal direction with a relative speed V. It is to be understood, however, that the analysis would be similar for the case that the object 200 is moving toward the LIDAR device 100. For purposes of illustration, FIG. 4 shows the position of the object 200 as 200a at T1, as 200b at time T2, and as 200c at time T2. At time T1, the object position 200a has a horizontal distance, H, from the LIDAR device 100. At time T2, the object position 200b has a horizontal distance of H+V(T2−T1). At time T3, the object position 200c has a horizontal distance of H+V(T3−T1).

The directions 120, 122, and 124 intersect object positions 200a, 200b, and 200c, respectively. However, because of their different pitch angles, directions 120, 122, and 124 intersect the object 200 at different points, which are shown in FIG. 4 as points 420, 422, and 424, respectively. Although the shape of the object 200 is unknown, it may be reasonable to assume that (on average) the directions 120, 122, and 124 intersect a locally planar surface of the object, such that the points of intersection 420, 422, and 424 are all collinear (in the frame of reference of the object 200). Thus, the surface of the object 200 may be modeled as a plane that has an angle ϕ relative to the vertical direction, as shown in FIG. 4. In that case, it can be shown that the ranges R1, R2, R3 are related to the unknown values of H, V, and ϕ, as follows:

$$\begin{matrix}R 1 = \frac{H}{cos θ1 + sin θ1tanϕ} & ( 4 ) \\ R 2 = \frac{H + V ( T 2 - T 1 )}{cos θ2 + sin θ2tanϕ} & ( 5 ) \\ R 3 = \frac{H + V ( T 3 - T 1 )}{cos θ3 + sin θ3tanϕ} & ( 6 )\end{matrix}$$

In an example implementation, equations (4), (5), and (6) can be solved using the measured values of R1, R2, and R3 to determine the unknowns H, V, and ϕ.

The calculation of V in the example shown in FIG. 4 may be simplified for the case that the pitch angles θ1, θ2, and θ3 are sufficiently small that their cosines are approximately one (small-angle approximation). Considering x-coordinates to be in the horizontal direction and y-coordinates to be in the vertical direction, the intersection points 420, 422, and 424 have coordinates (X1, Y1), (X2, Y2), and (X3, Y3). By applying the small-angle approximation and further assuming that the ranges R1, R2, and R3 are much greater than V(T3−T1), these coordinates can be approximated as follows:

(X1,Y1)=(R1,R1 sin θ1) (7)

(X2,Y2)=(R2,R2 sin θ2) (8)

(X3,Y3)=(R3,R3 sin θ3) (9)

Applying the assumption that these points are collinear, while taking into account the horizontal motion of the object from time T1 to T3, leads to the following requirement:

$$\frac{X 2 - V ( T 2 - T 1 ) - X 1}{Y 2 - Y 1} = \frac{X 3 - V ( T 3 - T 1 ) - X 2 - V ( T 2 - T 1 )}{Y 3 - Y 2} \qquad ( 10 )$$

Substituting in the values of X1, X2, X3, Y1, Y2, and Y3 shown in equations (7)-(9) and solving for V leads to the following:

$$V = \frac{\begin{matrix}( R 2 - R 1 ) ( R 3 sin θ3 - R 2 sin θ2 ) + \\ ( R 2 - R 3 ) ( R 2 sin θ2 - R 1 sin θ1 )\end{matrix}}{\begin{matrix}( T 2 - T 1 ) ( R 3 sin θ3 - R 2 sin θ2 ) + \\ ( T 2 - T 3 ) ( R 2 sin θ 2 - R 1 sin θ1 )\end{matrix}} \qquad ( 11 )$$

Thus, the relative speed can be determined based on the ranges, R1, R2, and R3, the times, T1, T2, and T3, and the pitch angles θ1, θ2, and θ3.

Although the example illustrated in FIG. 4 used three channels to determine three different ranges at three different times, it is to be understood that ranges could be determined from a greater number of channels, and V could be calculated as a best fit to the determined ranges. In addition, while the points of intersection were assumed to be collinear in the example described above, the surface of the object could be modeled in other ways. For example, five channels could be used to estimate the speed of the object that brings the points closest to fitting a parabola.

In an example implementation, the LIDAR device is coupled to an autonomous vehicle (e.g., to a roof, side mirror, grill, trunk, or fender, etc. of the vehicle), and the relative speed of the object is determined by a computing device coupled to the autonomous vehicle, such as inside the vehicle, inside a module attached to the vehicle, or wirelessly coupled to the vehicle. The computing device may use the relative speed of the object determined in this way to control the autonomous vehicle (e.g., to control a speed, acceleration, or direction of the autonomous vehicle).

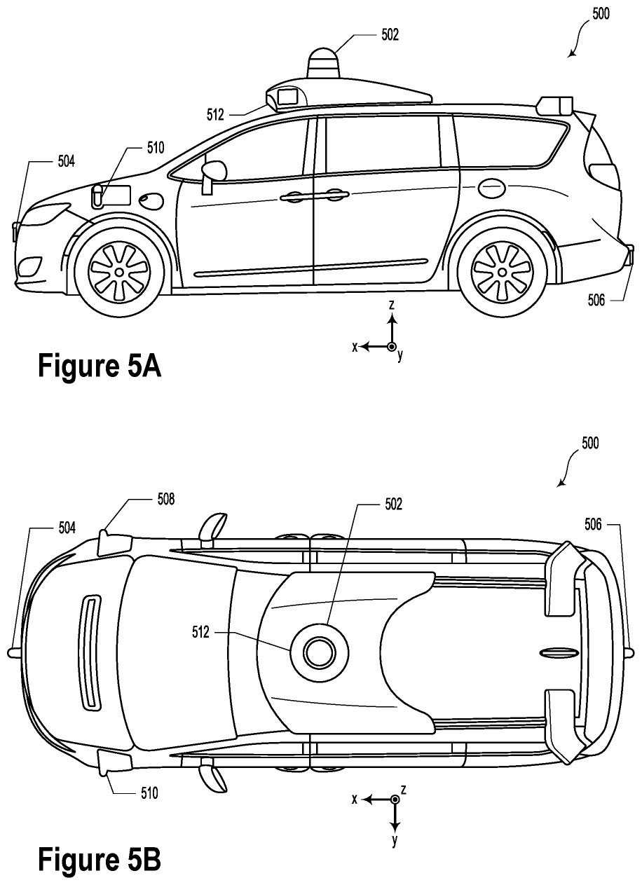

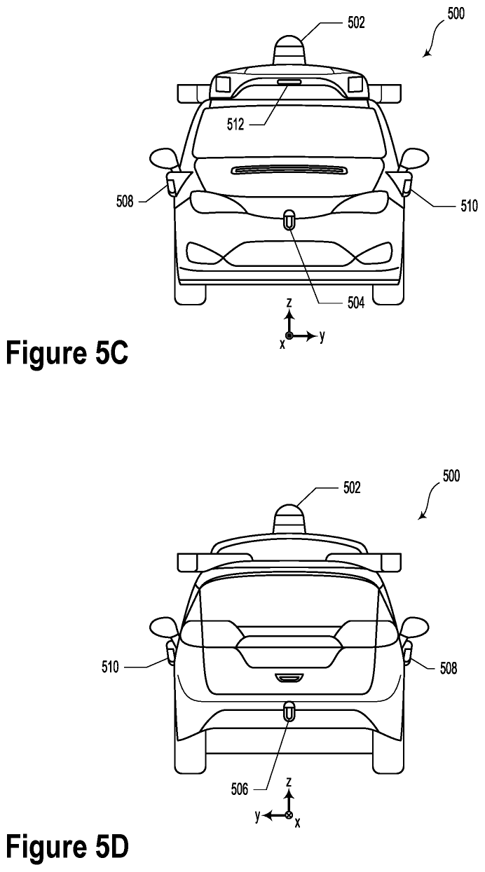

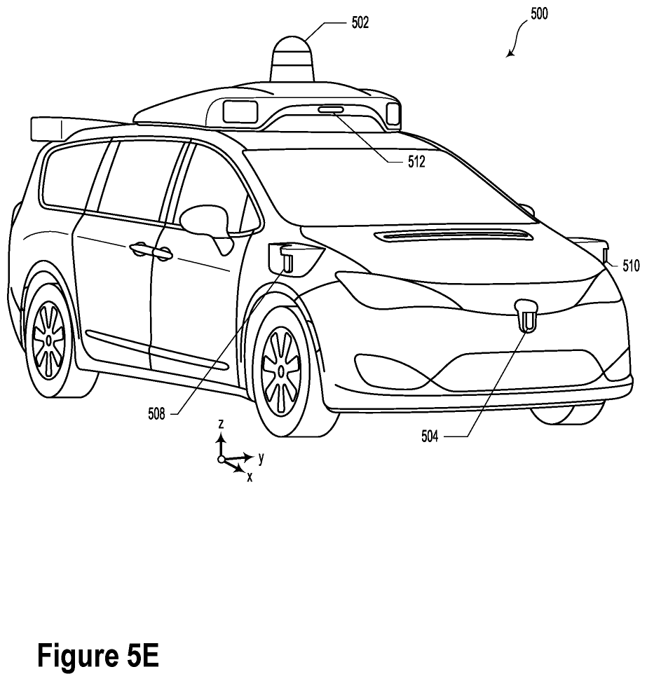

FIGS. 5A, 5B, 5C, 5D, and 5E illustrate a vehicle 500, according to an example embodiment. In some embodiments, the vehicle 500 could be a semi- or fully-autonomous vehicle. While FIGS. 5A, 5B, 5C, 5D, and 5E illustrates vehicle 500 as being an automobile (e.g., a passenger van), it should be understood that vehicle 500 could include any type of motor vehicle (cars, trucks, buses, motorcycles, all-terrain vehicles, recreational vehicle, any specialized farming or construction vehicles, etc.), aircraft (planes, helicopters, drones, etc.), naval vehicles (ships, boats, yachts, submarines, etc.), or any other self-propelled vehicles (robots, factory or warehouse robotic vehicles, sidewalk delivery robotic vehicles, etc.) capable of navigating (either without a human input or with a reduced human input) within its environment using sensors and other information about its environment.

In some examples, the vehicle 500 may include one or more sensor systems 502, 504, 506, 508, 510, and 512. In some embodiments, sensor systems 502, 504, 506, 508, 510, and/or 512 could include the LIDAR device 100 having a plurality of channels with each channel having at least one light emitter and at least one light detector as described above. In other words, the systems described elsewhere herein could be coupled to the vehicle 500 and/or could be utilized in conjunction with various operations of the vehicle 500. As an example, the LIDAR device 100 could be included in one or more of the sensor systems 502, 504, 506, 508, 510, and/or 512 and used by the control system to detect the relative speed of objects in the environment around the vehicle 500.

While the one or more sensor systems 502, 504, 506, 508, 510, and 512 are illustrated on certain locations on vehicle 500, it will be understood that more or fewer sensor systems could be utilized with vehicle 500. Furthermore, the locations of such sensor systems could be adjusted, modified, or otherwise changed as compared to the locations of the sensor systems illustrated in FIGS. 5A, 5B, 5C, 5D, and 5E.

One or more of the sensor systems 502, 504, 506, 508, 510, and/or 512 could include LIDAR sensors. For example, the LIDAR sensors could include a plurality of light-emitter devices arranged over a range of angles with respect to a given plane (e.g., the x-y plane). For example, one or more of the sensor systems 502, 504, 506, 508, 510, and/or 512 may be configured to rotate about an axis (e.g., the z-axis) perpendicular to the given plane so as to illuminate an environment around the vehicle 500 with light pulses. Based on detecting various aspects of reflected light pulses (e.g., the elapsed time of flight, polarization, intensity, etc.), information about the environment may be determined.

The vehicle 500 may also include additional types of sensors mounted on the exterior thereof. For example, one or more of the sensor systems 502, 504, 506, 508, 510, and/or 512 could include a temperature sensor, sound sensor, radio detection and ranging system (RADAR), sound navigation and ranging system (SONAR), global positioning system (GPS), and/or cameras. Each of these additional types of sensors would be communicably coupled to computer readable memory. The vehicle 500 may further include sensors mounted internally, such as inertial measurement units (IMUs) and/or Global Positioning System (GPS) units.

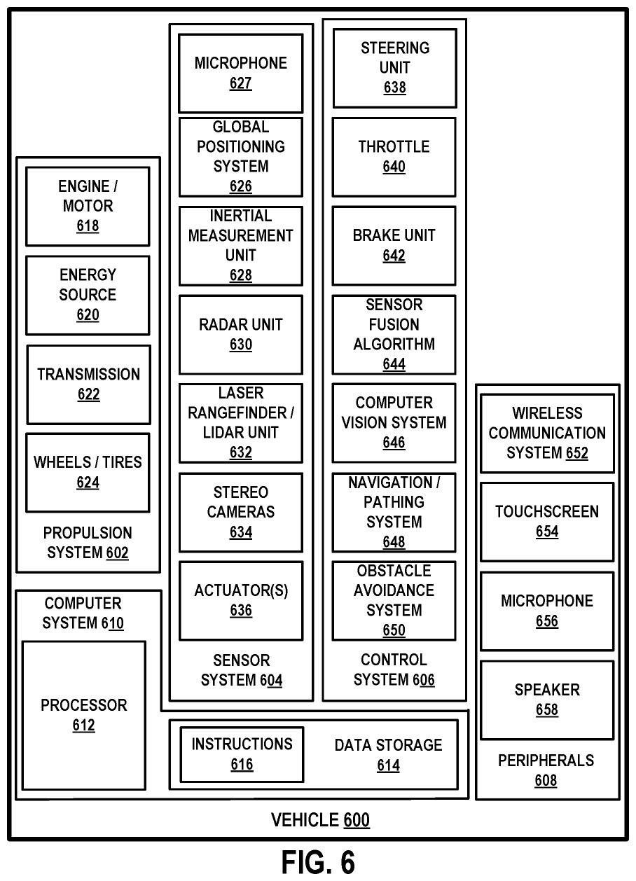

FIG. 6 is a simplified block diagram of a vehicle 600, such as the vehicle 500 described above, according to an example embodiment. As shown, the vehicle 600 includes a propulsion system 602, a sensor system 604, a control system 606, peripherals 608, and a computer system 610. In some embodiments, vehicle 600 may include more, fewer, or different systems, and each system may include more, fewer, or different components. Additionally, the systems and components shown may be combined or divided in any number of ways. For instance, control system 606 and computer system 610 may be combined into a single system.

Propulsion system 602 may be configured to provide powered motion for the vehicle 600. To that end, as shown, propulsion system 602 includes an engine/motor 618, an energy source 620, a transmission 622, and wheels/tires 624.

The engine/motor 618 may be or include any combination of an internal combustion engine, an electric motor, a steam engine, and a Sterling engine. Other motors and engines are possible as well. In some embodiments, propulsion system 602 may include multiple types of engines and/or motors. For instance, a gas-electric hybrid car may include a gasoline engine and an electric motor. Other examples are possible.

Energy source 620 may be a source of energy that powers the engine/motor 618 in full or in part. That is, engine/motor 618 may be configured to convert energy source 620 into mechanical energy. Examples of energy sources 620 include gasoline, diesel, propane, other compressed gas-based fuels, ethanol, solar panels, batteries, and other sources of electrical power. Energy source(s) 620 may additionally or alternatively include any combination of fuel tanks, batteries, capacitors, and/or flywheels. In some embodiments, energy source 620 may provide energy for other systems of the vehicle 600 as well. To that end, energy source 620 may additionally or alternatively include, for example, a rechargeable lithium-ion or lead-acid battery. In some embodiments, energy source 620 may include one or more banks of batteries configured to provide the electrical power to the various components of vehicle 600.

Transmission 622 may be configured to transmit mechanical power from the engine/motor 618 to the wheels/tires 624. To that end, transmission 622 may include a gearbox, clutch, differential, drive shafts, and/or other elements. In embodiments where the transmission 622 includes drive shafts, the drive shafts may include one or more axles that are configured to be coupled to the wheels/tires 624.

Wheels/tires 624 of vehicle 600 may be configured in various formats, including a unicycle, bicycle/motorcycle, tricycle, or car/truck four-wheel format. Other wheel/tire formats are possible as well, such as those including six or more wheels. In any case, wheels/tires 624 may be configured to rotate differentially with respect to other wheels/tires 624. In some embodiments, wheels/tires 624 may include at least one wheel that is fixedly attached to the transmission 622 and at least one tire coupled to a rim of the wheel that could make contact with the driving surface. Wheels/tires 624 may include any combination of metal and rubber, or combination of other materials. Propulsion system 602 may additionally or alternatively include components other than those shown.

Sensor system 604 may include a number of sensors configured to sense information about an environment in which the vehicle 600 is located, as well as one or more actuators 636 configured to modify a position and/or orientation of the sensors. The sensor system 604 further includes computer readable memory which receives and stores data from the sensors. As shown, sensor system 604 includes a microphone 627, a GPS unit 626, an IMU 628, a RADAR unit 630, a laser rangefinder and/or LIDAR unit 632, and a stereo camera system 634. Sensor system 604 may include additional sensors as well, including, for example, sensors that monitor internal systems of the vehicle 600 (e.g., an 02 monitor, a fuel gauge, an engine oil temperature, etc.). Other sensors are possible as well. The sensor system 604 can include the LIDAR device 100 described above.

The microphone module 627 may be any sensor (e.g., acoustic sensor) configured to detect and record sounds originating outside of the vehicle 600.

GPS 626 may be any sensor (e.g., location sensor) configured to estimate a geographic location of vehicle 600. To this end, the GPS 626 may include a transceiver configured to estimate a position of the vehicle 600 with respect to the Earth.

IMU 628 may be any combination of sensors configured to sense position and orientation changes of the vehicle 600 based on inertial acceleration. In some embodiments, the combination of sensors may include, for example, accelerometers, gyroscopes, compasses, etc.

RADAR unit 630 may be any sensor configured to sense objects in the environment in which the vehicle 600 is located using radio signals. In some embodiments, in addition to sensing the objects, RADAR unit 630 may additionally be configured to sense the speed and/or heading of the objects.

Similarly, laser range finder or LIDAR unit 632 may be any sensor configured to sense objects in the environment in which vehicle 600 is located using lasers. For example, LIDAR unit 632 may include one or more LIDAR devices, at least some of which may take the form of device 100 among other LIDAR device configurations, for instance.

The stereo cameras 634 may be any cameras (e.g., a still camera, a video camera, etc.) configured to capture images of the environment in which the vehicle 600 is located.

Control system 606 may be configured to control one or more operations of vehicle 600 and/or components thereof. To that end, control system 606 may include a steering unit 638, a throttle 640, a brake unit 642, a sensor fusion algorithm 644, a computer vision system 646, navigation or pathing system 648, and an obstacle avoidance system 650. In some examples, the control system 606 includes a controller configured to receive data from the plurality of channels of the LIDAR devices described herein.

Steering unit 638 may be any combination of mechanisms configured to adjust the heading of vehicle 600. Throttle 640 may be any combination of mechanisms configured to control engine/motor 618 and, in turn, the speed of vehicle 600. Brake unit 642 may be any combination of mechanisms configured to decelerate vehicle 600. For example, brake unit 642 may use friction to slow wheels/tires 624. As another example, brake unit 642 may convert kinetic energy of wheels/tires 624 to an electric current.

Sensor fusion algorithm 644 may be an algorithm (or a computer program product storing an algorithm) configured to accept data from sensor system 604 as an input. The sensor fusion algorithm 644 is operated on a processor, such as the external processor discussed above. The data may include, for example, data representing information sensed by sensor system 604. Sensor fusion algorithm 644 may include, for example, a Kalman filter, a Bayesian network, a machine learning algorithm, an algorithm for some of the functions of the methods herein, or any other sensor fusion algorithm. Sensor fusion algorithm 644 may further be configured to provide various assessments based on the data from sensor system 604, including, for example, evaluations of individual objects and/or features in the environment in which vehicle 600 is located, evaluations of particular situations, and/or evaluations of possible impacts based on particular situations. Other assessments are possible as well.

Computer vision system 646 may be any system configured to process and analyze images captured by stereo cameras 634 in order to identify objects and/or features in the environment in which vehicle 600 is located, including, for example, traffic signals and obstacles. To that end, computer vision system 646 may use an object recognition algorithm, a Structure from Motion (SFM) algorithm, video tracking, or other computer vision techniques. In some embodiments, computer vision system 646 may additionally be configured to map the environment, track objects, estimate the speed of objects, etc.

Navigation and pathing system 648 may be any system configured to determine a driving path for vehicle 600. Navigation and pathing system 648 may additionally be configured to update a driving path of vehicle 600 dynamically while vehicle 600 is in operation. In some embodiments, navigation and pathing system 648 may be configured to incorporate data from sensor fusion algorithm 644, GPS 626, microphone 627, LIDAR unit 632, and/or one or more predetermined maps so as to determine a driving path for vehicle 600.

Obstacle avoidance system 650 may be any system configured to identify, evaluate, and avoid or otherwise negotiate obstacles in the environment in which vehicle 600 is located. Control system 606 may additionally or alternatively include components other than those shown.

Peripherals 608 may be configured to allow vehicle 600 to interact with external sensors, other vehicles, external computing devices, and/or a user. To that end, peripherals 608 may include, for example, a wireless communication system 652, a touchscreen 654, a microphone 656, and/or a speaker 658.

Wireless communication system 652 may be any system configured to wirelessly couple to one or more other vehicles, sensors, or other entities, either directly or via a communication network. To that end, wireless communication system 652 may include an antenna and a chipset for communicating with the other vehicles, sensors, servers, or other entities either directly or via a communication network. The chipset or wireless communication system 652 in general may be arranged to communicate according to one or more types of wireless communication (e.g., protocols) such as Bluetooth, communication protocols described in IEEE 802.11 (including any IEEE 802.11 revisions), cellular technology (such as GSM, CDMA, UMTS, EV-DO, WiMAX, or LTE), Zigbee, dedicated short range communications (DSRC), and radio frequency identification (RFID) communications, among other possibilities.

Touchscreen 654 may be used by a user to input commands to vehicle 600. To that end, touchscreen 654 may be configured to sense at least one of a position and a movement of a user's finger via capacitive sensing, resistance sensing, or a surface acoustic wave process, among other possibilities. Touchscreen 654 may be capable of sensing finger movement in a direction parallel or planar to the touchscreen surface, in a direction normal to the touchscreen surface, or both, and may also be capable of sensing a level of pressure applied to the touchscreen surface. Touchscreen 654 may be formed of one or more translucent or transparent insulating layers and one or more translucent or transparent conducting layers. Touchscreen 654 may take other forms as well.

Microphone 656 may be configured to receive audio (e.g., a voice command or other audio input) from a user of vehicle 600. Similarly, speakers 658 may be configured to output audio to the user.

Computer system 610 may be configured to transmit data to, receive data from, interact with, and/or control one or more of propulsion system 602, sensor system 604, control system 606, and peripherals 608. To this end, computer system 610 may be communicatively linked to one or more of propulsion system 602, sensor system 604, control system 606, and peripherals 608 by a system bus, network, and/or other connection mechanism (not shown).

In one example, computer system 610 may be configured to control operation of transmission 622 to improve fuel efficiency. As another example, computer system 610 may be configured to cause camera 634 to capture images of the environment. As yet another example, computer system 610 may be configured to store and execute instructions corresponding to sensor fusion algorithm 644. As still another example, computer system 610 may be configured to store and execute instructions for determining a 3D representation of the environment around vehicle 600 using LIDAR unit 632. Thus, for instance, computer system 610 could function as a controller for LIDAR unit 632. Other examples are possible as well.

As shown, computer system 610 includes processor 612 and data storage 614. Processor 612 may comprise one or more general-purpose processors and/or one or more special-purpose processors. To the extent that processor 612 includes more than one processor, such processors could work separately or in combination.

In some examples, the processor 612 of computer system 610 is configured to execute instructions stored in data storage 614 to control sensors in the sensor system 604, to schedule data transmissions (e.g., to avoid data loss as the result of memory blackout events), and to perform other functions. Alternatively or additionally, the instructions may cause the processor 612 to schedule memory blackout events so as to avoid data loss during the memory blackout events.

Data storage 614, in turn, may comprise one or more volatile and/or one or more non-volatile storage components, such as optical, magnetic, and/or organic storage, and data storage 614 may be integrated in whole or in part with processor 612. In some embodiments, data storage 614 may contain instructions 616 (e.g., program logic) executable by processor 612 to cause vehicle 600 and/or components thereof (e.g., LIDAR unit 632, etc.) to perform the various operations described herein. Data storage 614 may contain additional instructions as well, including instructions to transmit data to, receive data from, interact with, and/or control one or more of propulsion system 602, sensor system 604, control system 606, and/or peripherals 608.

In some embodiments, vehicle 600 may include one or more elements in addition to or instead of those shown. For example, vehicle 600 may include one or more additional interfaces and/or power supplies. Other additional components are possible as well. In such embodiments, data storage 614 may also include instructions executable by processor 612 to control and/or communicate with the additional components. Still further, while each of the components and systems are shown to be integrated in vehicle 600, in some embodiments, one or more components or systems may be removably mounted on or otherwise connected (mechanically or electrically) to vehicle 600 using wired or wireless connections. Vehicle 600 may take other forms as well.

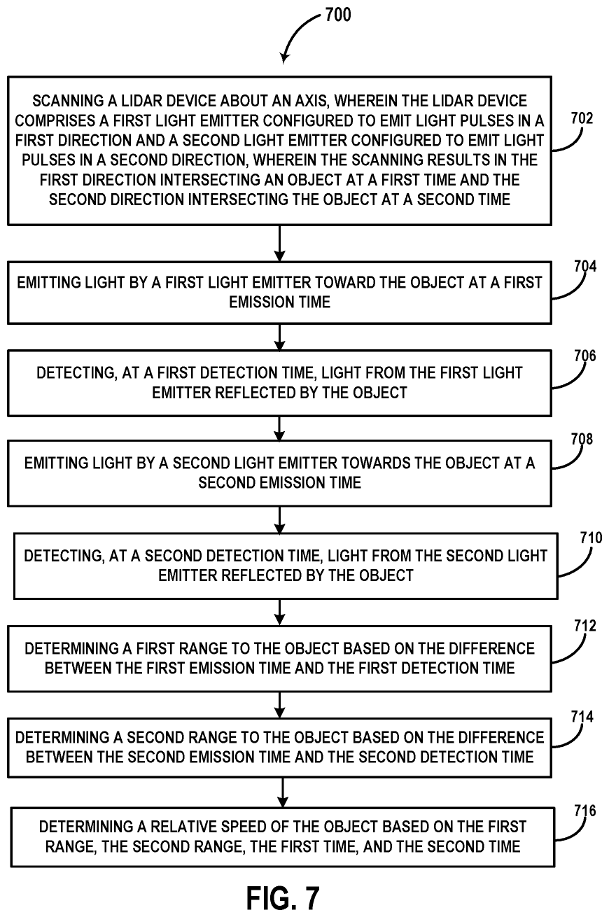

FIG. 7 is a flowchart of a method 700, according to example embodiments. The method 700 presents an embodiment of a method that could be used with the sensor system 10, the LIDAR device 100, or the vehicles 500 and 600, for example. Method 700 may include one or more operations, functions, or actions as illustrated by one or more of blocks 702-716. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

The method 700 is a method of determining the speed of an object. More specifically, the method 700 is a method of determining the speed of an object relative to a LIDAR device by using data from at least two channels of the LIDAR device.

In addition, for method 700 and other processes and methods disclosed herein, the flowchart shows functionality and operation of one possible implementation of present embodiments. In this regard, each block may represent a module, a segment, a portion of a manufacturing or operation process, or a portion of program code, which includes one or more instructions executable by a processor for implementing specific logical functions or steps in the process. The program code may be stored on any type of computer readable medium, for example, such as a storage device including a disk or hard drive. In some forms, the program code is stored on the data storage units described in the embodiments above.

The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for method 700 and other processes and methods disclosed herein, each block in FIG. 7 may represent circuitry that is wired to perform the specific logical functions in the process.

At block 702, the method 700 includes scanning a LIDAR device about an axis. In this example, the LIDAR device is a multiple channel LIDAR device, such as the LIDAR device 100 described above. The LIDAR device includes a first channel having a first light emitter and a first light detector. The first light emitter is configured to emit light pulses in a first direction. The LIDAR device further comprises a second channel having a second light emitter and a second light detector. The second light emitter is configured to emit light pulses in a second direction. The first direction and the second direction comprise a first yaw angle and a second yaw angle, respectively, in a reference plane perpendicular to the axis about which the LIDAR device scans. A yaw angle difference between the first yaw angle and the second yaw angle is less than 90 degrees. Scanning the LIDAR device results in the first direction intersecting an object at a first time and the second direction intersecting the object at a second time.

At block 704, the method 700 involves emitting light by the first light emitter toward the object (e.g., while the first direction intersects the object) at a first emission time.

At block 706, the method 700 involves detecting light by the first light detector at a first detection time. The light detected by the first light detector includes a portion of the light emitted by the first light emitter which is reflected by the object.

At block 708, the method 700 involves emitting light by the second light emitter toward an object (e.g., while the second direction intersects the object) at a second emission time.

At block 710, the method 700 involves detecting light by the second light detector at a second detection time. The light detected by the second light detector includes a portion of the light emitted by the second light emitter which is reflected by the object.

At block 712, the method 700 includes determining a first range to the object from the LIDAR device. The first range is determined based on the difference in time between the first emission time and the first detection time, as described above.

At block 714, the method 700 includes determining a second range to the object from the LIDAR device. The second range is determined based on the difference in time between the second emission time and the second detection time, as described above.

At block 716, the method 700 includes determining a relative speed of the object based on the first range, the second range, the first time, and the second time. The first time is a time at which the first direction intersects the object. Similarly, the second time is a time at which the second direction intersects the object. In some forms, the first time is the first emission time and the second time is the second emission time. In some embodiments, the relative speed is determined by additionally using the relative orientation of the LIDAR device at the first time and the second time. For example, the calculation determines a portion of the object's speed moving transverse to the first and second direction based on the difference in the yaw angle of the first direction at the first time and the second direction at the second time.

In some embodiments, the LIDAR device includes additional channels, such as a third channel and a fourth channel. The additional channels have respective directions different from the first direction and the second direction. The additional channels can be used to determine respective ranges to the object at additional times to further determine the speed of the object relative to the LIDAR device.

The particular arrangements shown in the Figures should not be viewed as limiting. It should be understood that other implementations may include more or less of each element shown in a given Figure. Further, some of the illustrated elements may be combined or omitted. Yet further, an exemplary implementation may include elements that are not illustrated in the Figures. Additionally, while various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims. Other implementations may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations.

What is claimed is:

1. A method, comprising:
scanning a light detection and ranging (LIDAR) device about an axis, wherein the LIDAR device comprises a first light emitter, a second light emitter, a first light detector, and a second light detector, wherein the first light emitter is configured to emit light pulses in a first direction and the second light emitter is configured to emit light pulses in a second direction, wherein the first direction comprises a first yaw angle in a reference plane perpendicular to the axis and the second direction comprises a second yaw angle in the reference plane, wherein a yaw angle difference between the first yaw angle and the second yaw angle is less than 90 degrees, and wherein scanning the LIDAR device results in the first direction intersecting an object at a first time and the second direction intersecting the object at a second time;
emitting, by the first light emitter, a first emitted light pulse at a first emission time and detecting, by the first light detector, a first detected light pulse at a first detection time, wherein the first detected light pulse corresponds to reflection of the first emitted light pulse by the object;
emitting, by the second light emitter, a second emitted light pulse at a second emission time and detecting, by the second light detector, a second detected light pulse at a second detection time, wherein the second detected light pulse corresponds to reflection of the second emitted light pulse by the object;
determining a first range to the object based on a difference between the first emission time and the first detection time;
determining a second range to the object based on a difference between the second emission time and the second detection time; and
determining a relative speed of the object based on the first range, the second range, the first time, and the second time.

2. The method of claim 1, wherein the yaw angle difference between the first yaw angle and the second yaw angle is less than 10 degrees.

3. The method of claim 1, wherein the LIDAR device has a period of rotation that corresponds to a time to complete one scan about the axis, and wherein a time difference between the first time and the second time is a fraction of the period of rotation, the fraction being dependent on the yaw angle difference between the first yaw angle and the second yaw angle.

4. The method of claim 1, wherein the LIDAR device further comprises a third light emitter and a third light detector, wherein the third light emitter is configured to emit light pulses in a third direction, wherein the third direction comprises a third yaw angle in the reference plane, wherein a yaw angle difference between the second yaw angle and the third yaw angle is less than 90 degrees, and wherein scanning the LIDAR device results in the third direction intersecting the object at a third time, further comprising:
emitting, by the third light emitter, a third emitted light pulse at a third emission time and detecting, by the third light detector, a third detected light pulse at a third detection time, wherein the third detected light pulse corresponds to reflection of the third emitted light pulse by the object; and
determining a third range to the object based on a difference between the third emission time and the third detection time,
wherein determining the relative speed of the object is based on the first range, the second range, the third range, the first time, the second time, and the third time.

5. The method of claim 4, wherein the first direction comprises a first pitch angle relative to the reference plane, the second direction comprises a second pitch angle relative to the reference plane, and the third direction comprises a third pitch angle relative to the reference plane, wherein determining the relative speed of the object is based on the first range, the second range, the third range, the first time, the second time, the third time, the first pitch angle, the second pitch angle, and the third pitch angle.

6. The method of claim 5, wherein the axis is a vertical axis and the reference plane is a horizontal plane.

7. The method of claim 6, wherein at least one of the first pitch angle, the second pitch angle, or the third pitch angle is a negative pitch angle corresponding to a downward direction relative to the horizontal plane.

8. The method of claim 6, wherein at least one of the first pitch angle, the second pitch angle, or the third pitch angle is a positive pitch angle corresponding to an upward direction relative to the horizontal plane.

9. The method of claim 5, wherein the third yaw angle of the third direction is equal to the first yaw angle of the first direction, and wherein the second pitch angle of the second direction is between the first pitch angle of the first direction and the third pitch angle of the third direction.

10. The method of claim 1, wherein the LIDAR device is coupled to a vehicle.

11. The method of claim 10, further comprising controlling the vehicle based on the speed of the object relative to the vehicle.

12. A system, comprising:
a light detection and ranging (LIDAR) device configured to scan about an axis, wherein the LIDAR device comprises a first light emitter, a second light emitter, a first light detector, and a second light detector, wherein the first light emitter is configured to emit light pulses in a first direction and the second light emitter is configured to emit light pulses in a second direction, wherein the first direction comprises a first yaw angle in a reference plane perpendicular to the axis and the second direction comprises a second yaw angle in the reference plane, wherein a yaw angle difference between the first yaw angle and the second yaw angle is less than 90 degrees; and
a computing device coupled to the LIDAR device, wherein the computing device comprises a processor and data storage that stores instructions that are executable by the processor to perform operations comprising:
receiving, from the LIDAR device, data indicative of a first emitted light pulse emitted by the first light emitter at a first emission time and a first detected light pulse detected by the first light detector at a first detection time, wherein the first detected light pulse corresponds to reflection of the first emitted light pulse by an object;
receiving, from the LIDAR device, data indicative of a second emitted light pulse emitted by the second light emitter at a second emission time and a second detected light pulse detected by the second light detector at a second detection time, wherein the second detected light pulse corresponds to reflection of the second emitted light pulse by the object;
determining a first range to the object based on a difference between the first emission time and the first detection time;
determining a second range to the object base on a difference between the second emission time and the second detection time; and
determining a relative speed of the object based on the first range, the second range, a first time when the first direction intersects the object, and a second time when the second direction intersects the object.

13. The system of claim 12, wherein the LIDAR device is coupled to a vehicle, and wherein the computing device transmits signals used to navigate the vehicle based on the relative speed of the object.

14. The system of claim 13, wherein the LIDAR device is coupled to an external surface of the vehicle, and wherein the axis is perpendicular to the external surface of the vehicle.

15. The system of claim 14, wherein the external surface of the vehicle comprises a top portion of the vehicle.

16. The system of claim 12, wherein the LIDAR device has a period of rotation that corresponds to a time to complete one scan about the axis, and wherein a time difference between the first time and the second time is a fraction of the period of rotation, the fraction being dependent on the yaw angle difference between the first yaw angle and the second yaw angle.

17. The system of claim 12, wherein:
the LIDAR device further comprises a third light emitter and a third light detector, wherein the third light emitter is configured to emit light pulses in a third direction, wherein the third direction comprises a third yaw angle in the reference plane, wherein a yaw angle difference between the second yaw angle and the third yaw angle is less than 90 degrees; and
the instructions that are executable by the processor to perform operations further comprises:
receiving, from the LIDAR device, data indicative of a third emitted light pulse emitted by the third light emitter at a third emission time and a third detected light pulse detected by the third light detector at a third detection time, wherein the third detected light pulse corresponds to reflection of the third emitted light pulse by the object; and
determining a third range to the object base on a difference between the third emission time and the third detection time; and
determining the relative speed of the object based on the first range, the second range, the third range, the first time, the second time, and a third time when the third direction intersects the object.

18. The system of claim 17, wherein the first direction comprises a first pitch angle relative to the reference plane, the second direction comprises a second pitch angle relative to the reference plane, and the third direction comprises a third pitch angle relative to the reference plane; and
wherein the instructions that are executable by the processor to perform operations further comprises:
determining the relative speed of the object based on the first range, the second range, the third range, the first time, the second time, the third time, the first pitch angle, the second pitch angle, and the third pitch angle.

19. A non-transitory computer readable medium, wherein the non-transitory computer readable medium stores instructions that are executable by one or more processors to perform operations comprising:
receiving, from a LIDAR device, data indicative of a first emitted light pulse emitted by a first light emitter at a first emission time and a first detected light pulse detected by a first light detector at a first detection time, wherein the first detected light pulse corresponds to reflection of the first emitted light pulse by an object, wherein the first light emitter is configured to emit light pulses in a first direction;
receiving, from the LIDAR device, data indicative of a second emitted light pulse emitted by a second light emitter at a second emission time and a second detected light pulse detected by a second light detector at a second detection time, wherein the second detected light pulse corresponds to reflection of the second emitted light pulse by the object, wherein the second light emitter is configured to emit light pulses in a second direction, and wherein the first direction and the second direction have a yaw angle difference less than 90 degrees;
determining a first range to the object based on a difference between the first emission time and the first detection time;
determining a second range to the object base on a difference between the second emission time and the second detection time; and
determining a relative speed of the object based on the first range, the second range, a first time when the first direction intersects the object, and a second time when the second direction intersects the object.

20. The non-transitory computer readable medium of claim 19, wherein the operations further comprise:
controlling a vehicle based on the relative speed of the object.
